(19) United States
(12) Patent Application Publication
(10) Pub. No.: US 2012/0019229 A1
(43) Pub. Date: Jan. 26, 2012

(54) VOLTAGE REGULATING CIRCUIT FOR PORTABLE ELECTRONIC DEVICE

(75) Inventor: MING-YUAN HSU, Tu-Cheng (TW)

(73) Assignee: HON HAI PRECISION INDUSTRY CO., LTD., Tu-Cheng (TW)

(21) Appl. No.: 12/872,127

(22) Filed: Aug. 31, 2010

(30) Foreign Application Priority Data
Jul. 23, 2010 (TW) 99124248

(51) Int. Cl. G05F 3/02

(52) U.S. Cl. 323/304

(57) ABSTRACT

A regulating circuit is used to regulate an output from a power supply to a load. The regulating circuit includes a regulator and a voltage dividing. The voltage dividing is connected between the power supply and the regulator.

### BACKGROUND

1. Technical Field

The disclosure generally relates to voltage regulating circuits, particularly to a voltage regulating circuit used with a portable electronic device.

2. Description of Related Art

Regulators such as lower dropout regulators (LDO) are widely used in portable electronic devices to regulate output voltage from a power supply to a load. However, when a disparity between the output voltage from the power supply and a load voltage is large, the voltage regulating circuit has a low efficiency and high power consumption. For example, when the output voltage of the power supply VCC is 19V, and the load voltage Vload is 3.3V, the efficiency of the voltage regulator η=3.3÷19V=17.37%. Therefore, the voltage regulating circuit may easily overheat because of the low efficiency and the high power consumption.

Therefore, there is room for improvement within the art.

### BRIEF DESCRIPTION OF THE DRAWINGS

Many aspects of the voltage regulating circuit for portable electronic device can be better understood with reference to the following drawings. The components in the drawings are not necessarily drawn to scale, the emphasis instead being placed upon clearly illustrating the principles of the voltage regulating circuit for portable electronic device.

FIG. 1 is a block diagram of a voltage regulating circuit used with a portable electronic device, according to an exemplary embodiment.

FIG. 2 is a block diagram of the voltage regulating circuit of FIG. 1, when a current flowing through the voltage regulating circuit is 20 mA.

FIG. 3 is a block diagram of the voltage regulating circuit of FIG. 1, when the current flowing through the voltage regulating circuit is 50 mA.

FIG. 4 is a table contrasting power consumption of a conventional regulator with a regulator and voltage dividing of FIG. 1, when the current flowing through the voltage regulating circuit is at 20 mA and at 50 mA.

### DETAILED DESCRIPTION

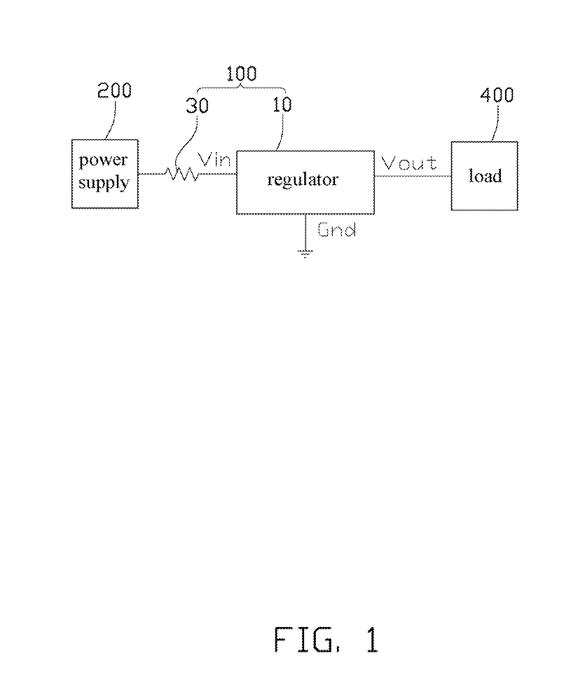

FIG. 1 shows a regulating circuit 100 used with a portable electronic device, according to an exemplary embodiment. In this exemplary embodiment, the regulating circuit 100 is used to regulate an output voltage from a power supply 200 to a load 400 of the portable electronic device. The regulating circuit 100 includes a regulator 10 and a voltage dividing 30 electrically connected to the regulator 10.

The regulator 10 is a three-terminal regulator including an input terminal Vin, a output terminal Vout, and a grounding terminal Gnd. The regulator 10 has a dropout voltage between the input terminal Vin and the output terminal Vout of about 0.5-1.1V. The input terminal Vin is connected to the power supply 200. The output terminal Vout is connected to the load 400. The grounding contact Gnd is grounded. The regulator 10 regulates the output voltage from the power supply 200 and outputs the regulated voltage to the load 400.

The voltage dividing 30 is connected between the power supply 200 and the input contact Vin. The output voltage from the power supply 200 is divided by the voltage dividing 30 and the regulator 10. In this exemplary embodiment, the voltage across the regulator 10 can be reduced because of the voltage dividing resistor 30. Therefore, when a current flowing through the regulator 10 is at a constant value, power consumption of the regulator 10 decreases.

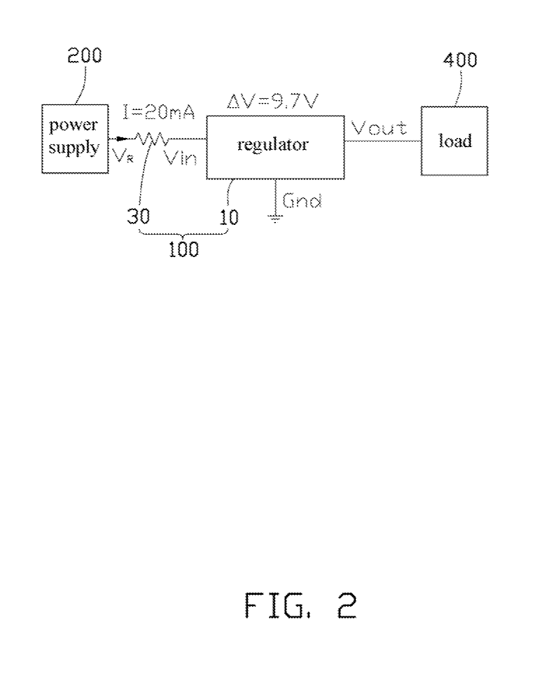

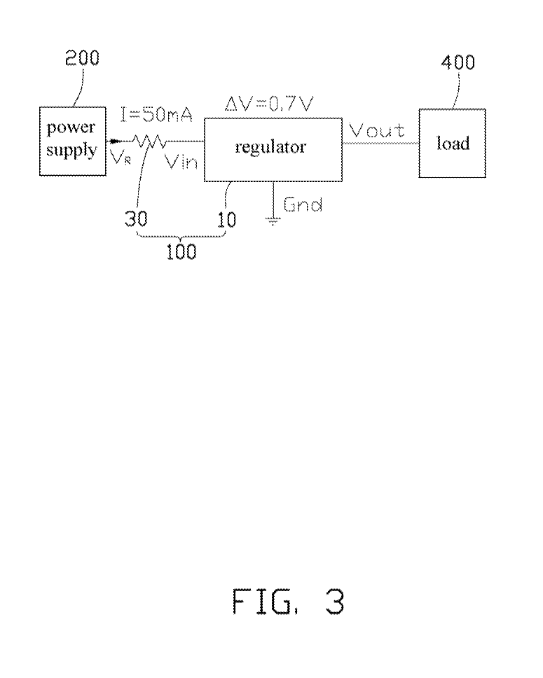

Referring to FIGS. 2, 3 and 4, in this exemplary embodiment, the regulator 10 is a G922T12 type regulator. The regulator 10 has a dropout voltage of about 0.7V, a rated current of about 20 mA, and a maximum current under a full load of about 50 mA. The voltage dividing 30 has a resistance of about 300Ω. The output voltage of the power supply 200 is about 19V. The load voltage is about 3.3V.

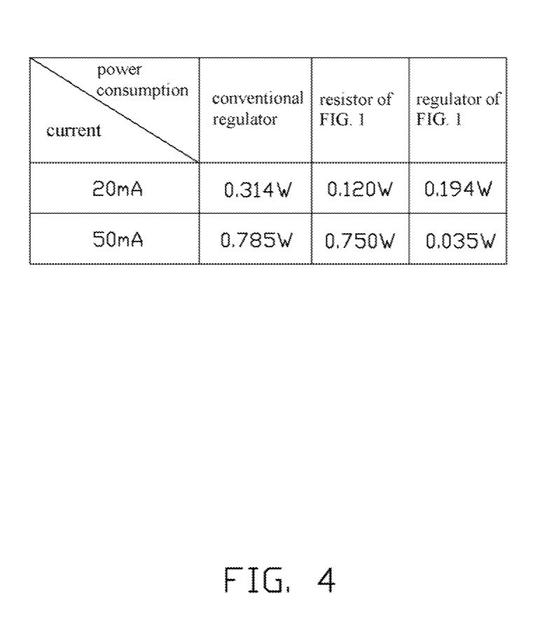

When a current I flowing through the voltage regulating circuit is 20 mA, the voltage drop across the voltage dividing 30 is V_{R}=300Ω*20 mA=6V. The voltage drop between the input contact Vin and the output contact Vout is ΔV=19V−6V−3.3V=9.7V. The power consumption of the regulator 10 is P=9.7V*20 mA=0.194 W which is decreased from a power consumption of a conventional regulator about 0.314 W (shown in FIG. 4).

When a current I flowing through the voltage regulating circuit is 50 mA, the voltage drop across the voltage dividing 30 is V_{R}=300Ω*50 mA=15V. The voltage drop between the input contact Vin and the output contact Vout is ΔV=19V−15V−3.3V=0.7V.

The power consumption of the regulator 10 is P=0.7V*20 mA=0.035 W which is decreased from a power consumption of a conventional regulator about 0.785 W (shown is FIG. 4). Therefore, the power consumption of the regulator 10 is decreased and overheating is avoided.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A regulating circuit used to regulate an output from a power supply to a load; comprising:
a regulator regulating the output from the power supply, and outputting the regulated voltage to the load; and
a voltage dividing connected between the power supply and the regulator.

2. The regulating circuit as claimed in claim 1, wherein the regulator is a three-terminal regulator including an input terminal connected to the power supply, an output terminal connected to the load and a grounding terminal grounded.

3. The regulating circuit as claimed in claim 1, wherein the regulator is a G922T12 type regulator.

4. The regulating circuit as claimed in claim 2, wherein the voltage dividing is connected between the input terminal and the power supply.

5. The regulating circuit as claimed in claim 4, wherein the voltage dividing has a resistance of about 300Ω.

6. A portable electronic device, comprising:
a power supply;
a load;
a regulator regulating the output from the power supply, and outputting the regulated voltage to the load; and
a voltage dividing connected between the power supply and the regulator.

7. The portable electronic device as claimed in claim 6, wherein the regulator is a three-terminal regulator including an input terminal connected to the power supply, an output terminal connected to the load and a grounding terminal grounded.

8. The portable electronic device as claimed in claim 6, wherein the regulator is a G922T12 type regulator.

9. The portable electronic device as claimed in claim 7, wherein the voltage dividing is connected between the input terminal and the power supply.

10. The portable electronic device as claimed in claim 9, wherein the voltage dividing has a resistance of about 300Ω.
